(19) United States
(12) Patent Application Publication
(10) Pub. No.: US 2010/0089198 A1
(43) Pub. Date: Apr. 15, 2010

(54) PEDAL DEVICE

(75) Inventors: Kenji Fujioka, Okayama (JP); Junji Ishii, Okayama (JP); Hideo Tsuboi, Okayama (JP); Yoshitaka Noda, Okayama (JP)

Correspondence Address: QUINN EMANUEL;KODA & ANDROLIA, 865 S. FIGUEROA STREET, 10TH FLOOR, LOS ANGELES, CA, 90017, US

(73) Assignee: HIRUTA-KOGYO CO., LTD., Okayama (JP)

(21) Appl. No.: 12/448,567

(22) PCT Filed: Dec. 26, 2007
(86) PCT No.: PCT/JP2007/074894

§ 371 Date: Jun. 25, 2009

(30) Foreign Application Priority Data
Dec. 27, 2006 (JP) 2006-352660

(51) Int. Cl. B62M 3/08

(52) U.S. Cl. 74/594.4

(57) ABSTRACT

A pedal device for a vehicle in which a support member for rotatably supporting a pedal arm is mounted on a dash panel positioned forward of a deck cross member. The pedal arm is pivotally attached to the support member by a pedal-rotating shaft inserted through a pedal shaft hole formed in the support member, and this support member has a pivotal impact lever which is provided above the pedal arm and forward of the deck cross member and brought down toward the pedal-rotating shaft.

### TECHNICAL FIELD

The present invention relates to a pedal device for a vehicle such as a brake pedal, an acceleration pedal, or a clutch pedal for dropping a pedal arm when a vehicle collides.

### BACKGROUND ART

There has been proposed a pedal device in which a pedal arm is dropped by collision of a vehicle to reduce or to prevent a risk of a pedal arm of a brake pedal and the like going back and hurting a leg of a driver when a vehicle such as an automobile collides. For instance, Patent Document 1 discloses a pedal device including a pedal dropping lever (actuating member) that fits a pedal rotating shaft of a pedal arm in a cutout groove of a support member (bracket) opened towards a lower side and drops the pedal-rotating shaft along the cutout groove by the collision of the vehicle. The pedal dropping lever is pivotally attached to the support member between a dash panel and the pedal arm, and swings so as to lift up a front end and push down a back end when pushed by the dash panel that goes back by the collision of the vehicle. The back end of the pedal dropping lever then pushes down and drops the pedal arm.

The pedal device disclosed in Patent Document 1 has a rotation shaft of the pedal arm sandwiched by parallel opposing edges of the cutout groove, and the pedal arm is rotatably supported with respect to the support member. Here, Patent Document 1 drops the pedal-rotating shaft of the pedal arm “along” the cutout groove, and thus the cutout groove is assumed to be merely a site having the parallel opposing edges so as to specify the dropping direction of the pedal arm. Thus, the cutout groove basically has a groove shape with the lower side opened, but the lower side of the cutout groove may be blocked to prevent unnecessary dropping of the pedal arm (see [0036] of Patent Document 1). Since the pedal arm is pushed down by the back end of the pedal dropping lever, the pedal rotating shaft is assumed to damage the lower side of the blocked cutout groove to drop the pedal arm.

[Patent Document 1] Japanese Unexamined Patent Publication No. 09-286256 (claim 1, claim 4, [0036])

### DISCLOSURE OF THE INVENTION

Problems to be Solved by the Invention

A pedal device of Patent Document 1 has a pedal rotating shaft sandwiched at a cutout groove having parallel opposing edges, and a pedal arm rotatably supported with respect to a support member to specify a dropping direction of the pedal arm. However, a portion contributing to supporting the pedal-rotating shaft is only one part of the opposing edges, and it is hard to say that the pedal arm can be stably supported. In the example of Patent Document 1, a boss is sandwiched at the cutout groove and the pedal-rotating shaft is pivotally attached to the boss, but in this case as well, a portion contributing to supporting the boss is very small, and thus stable supporting of the pedal arm cannot be realized as a result.

When seen from the support member, the cutout groove is merely a negative element that lowers rigidity, and the support member may deform by a load applied through the pedal-rotating shaft by a rapid operation of the pedal arm. If the support member deforms, this leads to deformation of the cutout groove, and not only inhibits a function of specifying the dropping direction of the pedal arm of the cutout groove, but also inhibits the dropping itself of the pedal arm. This is a problem that may occur when the support member deforms when a vehicle collides.

In addition, a pedal dropping lever swings by going back motion of a dash panel and drops the pedal arm, but as the support member pivotally attached with the pedal dropping lever is attached on the dash panel, the support member and furthermore the pedal dropping lever may go back along with the dash panel. In this case, the pedal dropping lever may not swing, and thus may not be able to drop the pedal arm. Therefore, the pedal device of Patent Document 1 has problems in stable supporting of the pedal arm, rigidity of the support member, and reliable operation of the pedal dropping lever. The pedal device for reliably dropping the pedal arm when the vehicle collides is thus reviewed to solve such problems.

Means for Solving the Problems

As a result of the review, there is developed a pedal device for a vehicle configured by mounting a support member for rotatably supporting the pedal arm on a dash panel positioned forward of a deck cross member, the pedal arm being pivotally attached to the support member by inserting a pedal-rotating shaft through a pedal shaft hole, and the support member being pivotally attached with an impact lever brought down toward the pedal-rotating shaft at above the pedal arm and forward of the deck cross member. The impact lever may be of any shape or size as long as it can be brought down with respect to the pedal rotating shaft, as long as it is pivotally attached to the support member backwards than the pedal-rotating shaft as the impact lever collides with the deck cross member from a front side and is brought down to the pedal arm.

The present invention enables the impact lever to be certainly brought down toward the pedal-rotating shaft as the impact lever is collided with the deck cross member relatively fixed in position with respect to the dash panel. Specifically, when the support member goes back with the dash panel towards the deck cross member when the vehicle collides, the impact lever first collides with the deck cross member and rotates downward. The impact lever that is rotated downward then collides with the pedal rotating shaft, and pushes the pedal arm downward. The pedal arm pushed downward in such a manner breaks the lower site of the pedal shaft hole of the support member by the pedal-rotating shaft and drops as is.

The impact lever is configured to include a rotating shaft impact part that is brought down to the pedal rotating shaft by the rotation having the lever-rotating shaft as a center. The rotating-shaft impact part merely needs to be arranged at one location with respect to the pedal-rotating shaft, but a configuration including a pair of rotating-shaft impact parts spaced apart in an extending direction of the pedal-rotating shaft is preferable. In other words, the impact lever pushes down the entire pedal rotating shaft in parallel when the pair of rotating-shaft impact parts are simultaneously brought down to the site close to both left and right ends of the pedal-rotating shaft, thereby reliably breaking the lower site of the pedal shaft hole and drop.

The impact lever may be distant from the pedal arm or may be brought into contact with the pedal arm in a normal state, but is not preferable if rattled by a vibration of the vehicle. Thus, the impact lever is preferably held at a position not interfering with the pedal arm in the normal state by a position holding part arranged on the support member. The rattling of the impact lever is thus suppressed or prevented, and furthermore, when the support member goes back with the dash panel towards the deck cross member, the impact lever collides with the deck cross member thereby breaking the position holding part and is brought down towards the pedal arm to apply a large impact on the pedal-rotating shaft. The pedal-rotating shaft thereby easily breaks the lower site of the pedal shaft hole, and enables the pedal arm to smoothly drop.

The present invention allows the pedal rotating shaft of the pedal arm to be supported with the pedal shaft hole formed in the support member, and thus the pedal arm can be stably supported and the rigidity of the support member can be ensured. However, there is a need to push down the pedal arm by the impact lever that is brought down, and break the lower site of the pedal shaft hole by the pedal rotating shaft. Thus, a width from an inner peripheral edge of the pedal shaft hole to a peripheral edge of the support member positioned on the lower side of the pedal shaft hole needs to be appropriately set in view of a raw material, a plate thickness, and the like of the member configuring the support member. Normally, the width is about a few mm if the support member is made of sheet metal. Moreover, the support member preferably has a cleavage eliciting portion formed at the lower site of the pedal shaft hole to which the pedal-rotating shaft, to which the impact lever is brought down, is pivotally attached. The cleavage eliciting portion may be a cutout formed at the inner peripheral edge of the pedal shaft hole or a cutout formed at the peripheral edge of the support member positioned on the lower side of the pedal shaft hole.

Effects of the Invention

According to the present invention, provided is a pedal device configured to stably support a pedal arm and without lowering rigidity of a support member, and allowing the pedal arm to drop by reliably bringing down an impact lever when a vehicle collides. This is due to an effect that the rigidity of the support member for supporting the pedal arm is sufficiently ensured, and a stable operation of the pedal arm is guaranteed as a normal state and a risk of the support member deforming at the time of rapid operation of the pedal arm and collision of the vehicle is eliminated, whereby only the pedal arm can be reliably dropped when the vehicle collides.

### BRIEF DESCRIPTION OF THE DRAWINGS

FIG. 1 is a side view illustrating a pedal device of one example based on the present invention.

FIG. 2 is a front view of the pedal device of the present example seen from a driver's side.

FIG. 3 is an exploded perspective view of the pedal device of the present example seen from the driver's side.

FIG. 4 is a partial cross-sectional view showing a structure of an impact lever of the present example.

FIG. 5 is a cross-sectional view corresponding to FIG. 4 illustrating a structure of an impact lever of another example.

FIG. 6 is a side view corresponding to FIG. 1 illustrating a pedal device of another example in which a cleavage eliciting portion is arranged at a lower site of a pedal shaft hole.

FIG. 7 is a side view corresponding to FIG. 1 showing a pedal device of another example in which an opening is arranged with respect to the pedal shaft hole.

FIG. 8 is a cross-sectional view corresponding to FIG. 4 illustrating the pedal device of another example.

FIG. 9 is a side view corresponding to FIG. 1 illustrating the pedal device at a stage in which a dash panel starts to go back.

FIG. 10 is a side view corresponding to FIG. 1 illustrating the pedal device at a stage in which the impact lever is brought down and reached to a pedal rotating shaft of a pedal arm.

FIG. 11 is a side view corresponding to FIG. 1 illustrating the pedal device at a stage in which the pedal-rotating shaft breaks a lower site of the pedal shaft hole and the pedal arm drops.

### DESCRIPTION OF SYMBOLS

1 Pedal arm

11 Arm main body

16 Pedal-rotating shaft

2 Support member

21 Member attachment part

22 Arm supporting part

24 Pedal shaft hole

25 Lever shaft hole

26 Removal part

261 Cleavage eliciting portion

28 Opening

29 Opened part

3 Impact lever

31 Lever main body

32 Deck contacting part

33 Rotating-shaft impact part

36 Position holding part

37 Lever-rotating shaft

4 Dash panel

5 Deck cross member

W Width from inner peripheral edge of pedal shaft hole to peripheral edge of support member positioned on lower side of pedal shaft hole

ΔW Width of cleavage eliciting portion

### BEST MODE FOR CARRYING OUT THE INVENTION

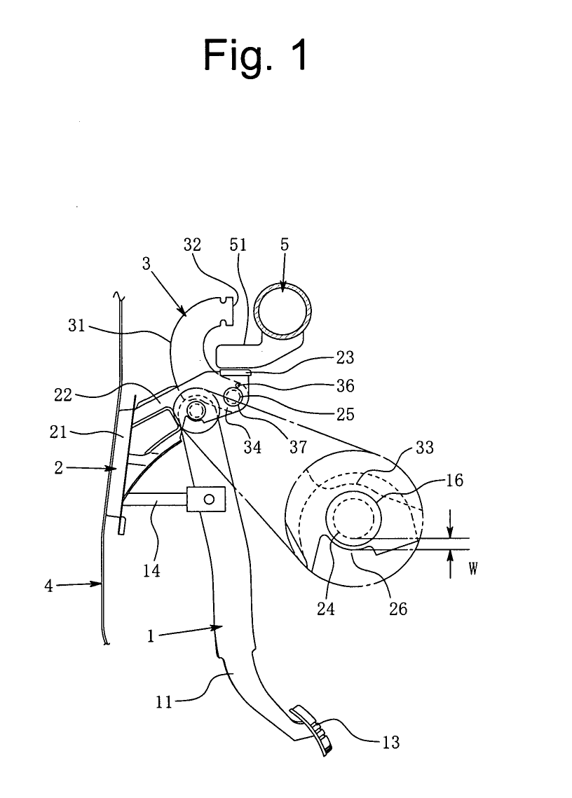

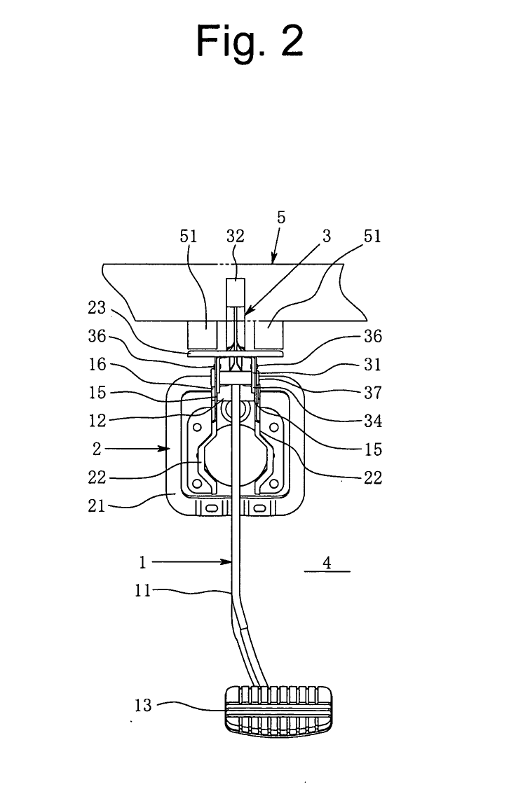

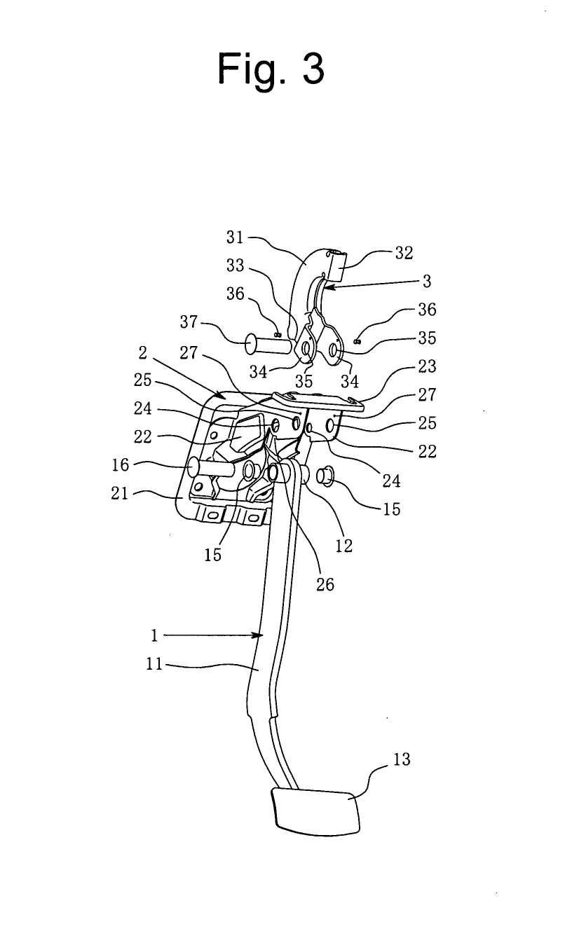

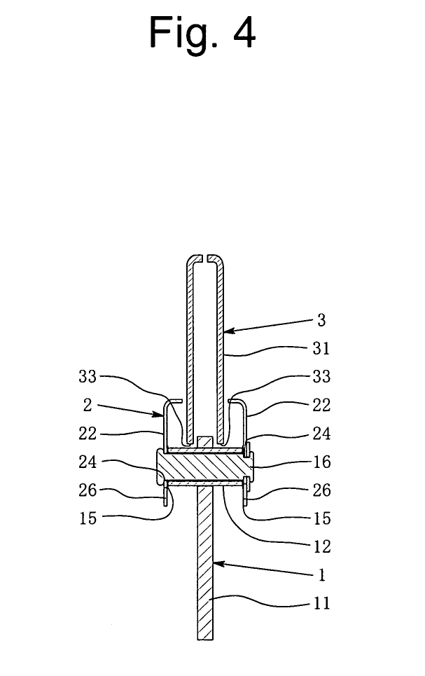

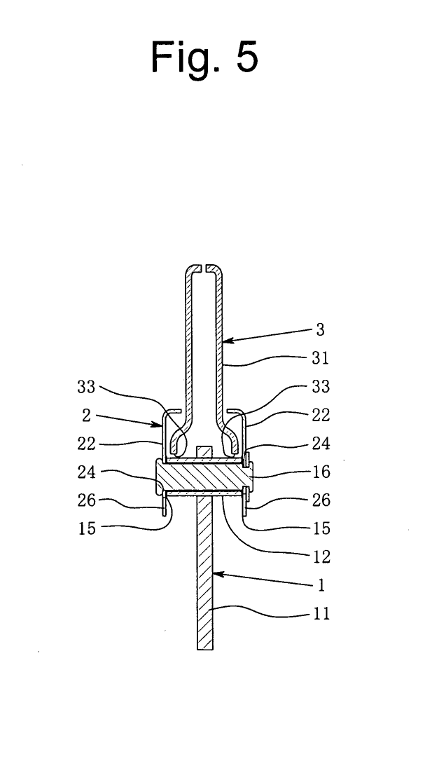

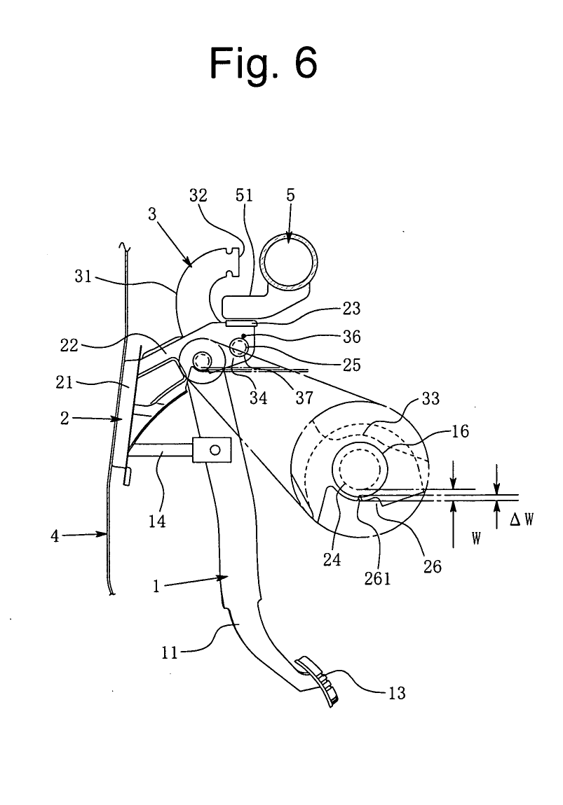

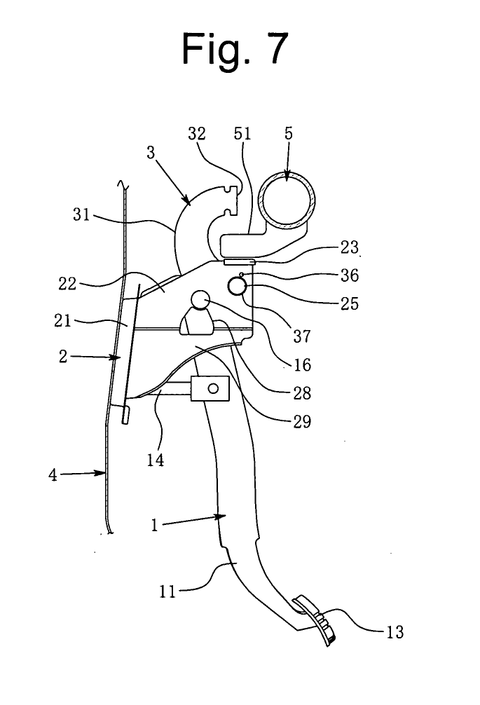

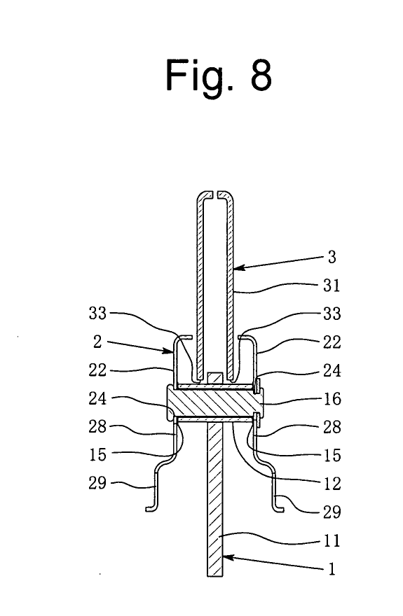

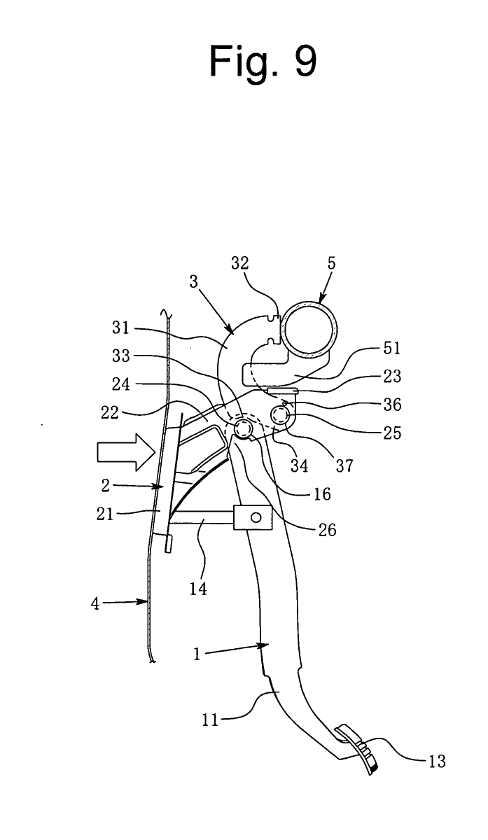

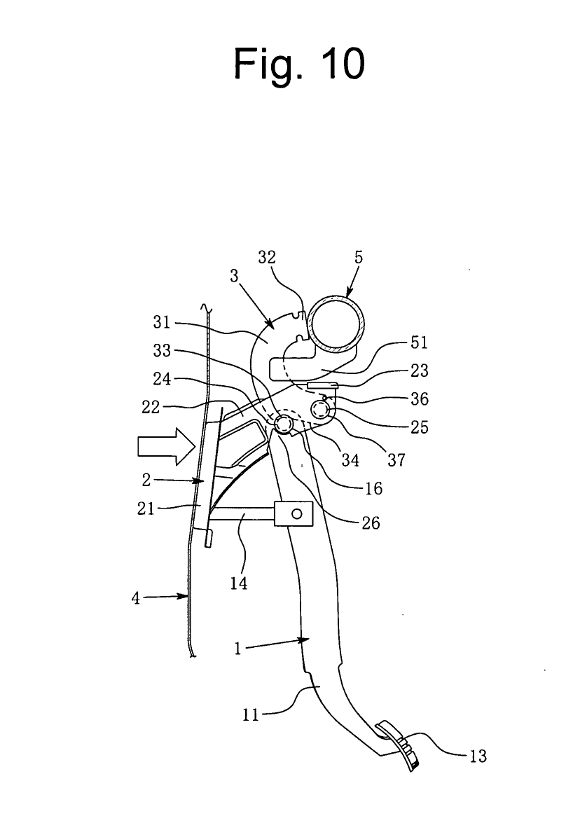

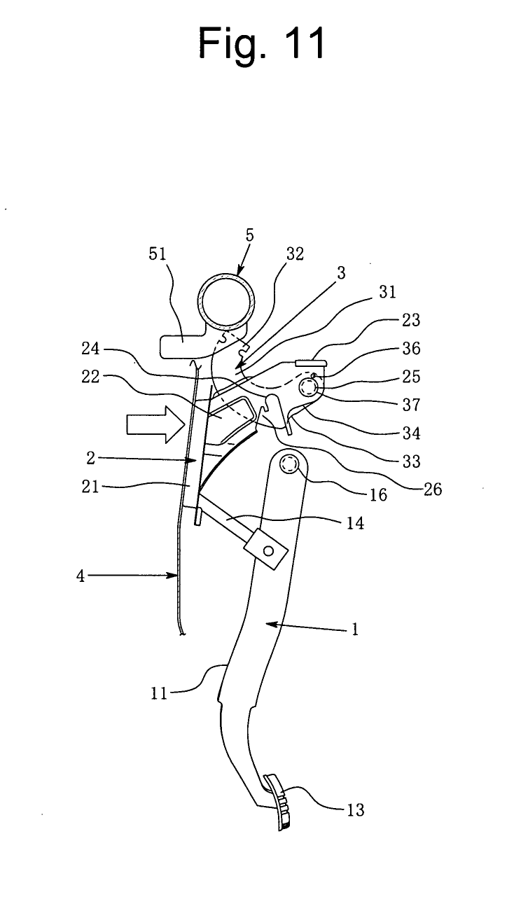

Hereinafter, an embodiment of the present invention will be described with reference to the drawings. FIG. 1 is a side view illustrating a pedal device of one example based on the present invention, FIG. 2 is a front view of the pedal device of the present example seen from a driver's side, FIG. 3 is an exploded perspective view of the pedal device of the present example seen from the driver's side, FIG. 4 is a partial cross-sectional view illustrating a structure of an impact lever 3 of the present example, FIG. 5 is a cross-sectional view corresponding to FIG. 4 illustrating a structure of an impact lever 3 of another example, FIG. 6 is a side view corresponding to FIG. 1 illustrating a pedal device of another example in which a cleavage eliciting portion 261 is arranged at a lower site of a pedal shaft hole 24, FIG. 7 is a side view corresponding to FIG. 1 illustrating a pedal device of another example in which an opening 28 is arranged with respect to the pedal shaft hole 24, FIG. 8 is a cross-sectional view corresponding to FIG. 4 illustrating the pedal device of another example, and FIGS. 9 to 11 are side views corresponding to FIG. 1 of the pedal device of the present example illustrating procedures in which a pedal arm 1 drops by collision of a vehicle, where FIG. 9 illustrates a stage in which a dash panel 4 starts to go back, FIG. 10 illustrates a stage in which the impact lever 3 is brought down and reaches a pedal-rotating shaft 16 of the pedal arm 1, and FIG. 11 illustrates a stage in which the pedal-rotating shaft 16 breaks the lower site of the pedal shaft hole 24 and the pedal arm 1 drops.

The pedal device of the present example is an example of a brake pedal, and is configured by mounting a support member 2 for rotatably supporting the pedal arm 1 on the dash panel 4 positioned forward of a deck cross member 5, as illustrated in FIGS. 1 to 3. A feature of the pedal device based on the present invention lies in that the impact lever 3 brought downward is pivotally attached to the support member 2 above the pedal arm 1 and forward of the deck cross member 5. An upper side of the pedal arm 1 and a forward side of the deck cross member 5 conventionally have a spatial margin, and the impact lever 3 can be easily added. A configuration of the pedal device of the present example excluding the impact lever 3 is not greatly different from a conventionally known pedal device of the same type, and thus the pedal device of the present invention is recognized to have versatility that can be easily applied even to the existing vehicles.

The pedal arm 1 is configured by mounting a shaft insertion pipe 12 to an upper end of a plate-shaped arm main body 11 curved to the driver's side towards the lower side, and a pedal pad 13 to a lower end of the arm main body 11. The pedal arm 1 is pivotally attached to the support member 2 by inserting the shaft insertion pipe 12 having bearing collars 15, 15 fitted to both left and right ends between arm supporting parts 22, 22 of the support member 2, and inserting a pedal-rotating shaft 16 over the pedal shaft holes 24, 24 formed at the arm supporting parts 22, 22. A step-in amount (rotation amount) of the pedal arm 1 is transmitted to a controller (not shown) as an advance/retreat amount of a link rod 14 (omitted for the sake of illustration in FIGS. 2 and 3) projected from the dash panel 4 and pivotally attached on the lower side of the pedal-rotating shaft 16 and near the middle of the arm main body 11.

The support member 2 is configured by a member attachment part 21 brought into contact and fixed to a surface of the dash panel 4, and the arm supporting parts 22, 22 of a pair of left and right flanges hanging out in parallel from the member attachment part 21. Each of the arm supporting parts 22, 22 has a pair of left and right pedal shaft holes 24, 24 for pivotally attaching the pedal arm 1 arranged near the middle on the front and the back, and has a pair of left and right lever shaft holes 25, 25 for pivotally attaching the impact lever 3 arranged above the pedal shaft hole 24 and closer to the deck cross member 5. Thus, the impact lever 3 brought down by being collided to the deck cross member 5 collides with the pedal-rotating shaft 16, thereby pushing down the pedal arm 1 and coinciding the majority of the motion direction until the pedal-rotating shaft 16 breaks the lower site of the pedal shaft hole 24 with the direction of gravitational force to facilitate the lowering of the pedal arm 1. Furthermore, in this example, a removal part 26 is formed in a constant range from the arm supporting part 22, so that the lower site become a band-shape copying the pedal shaft hole 24 and the lower site of the pedal shaft hole 24 is reliably broken by the pedal-rotating shaft 16 to which the impact lever 3 is brought down.

Each of the arm supporting parts 22, 22 of the support member 2 has pin holes 27, 27 for receiving a pin that becomes a position holding part 36 for holding the impact lever 3 at a position that does not interfere with the pedal arm 1 in a normal state near the lever shaft hole 25. The position holding part 36 may also be configured by arranging a projecting part that pressure contacts the impact lever 3 on each of the arm supporting parts 22, 22 in place of the pin. The impact lever 3 of the present example puts a rotating shaft impact part 33 in standby slightly distant to the upper side from the pedal-rotating shaft 16, and is held in the position that does not interfere with the pedal arm 1 by the position holding part 36. In addition, the support member 2 of the present example has a deck guide base 23 including a horizontal plate surface that slidably contacts a support guide rail 51 arranged on the deck cross member 5 bridged on the upper edges of the arm supporting parts 22, 22 such that the impact lever 3 properly collides with the deck cross member 5 when going back with the dash panel 4.

The impact lever 3 is configured by arranging a deck contacting part 32 at an upper end of a lever main body 31 having a C-shape in side view curved to a projecting form towards the dash panel 4, and axial attachment supporting parts 34, 34 at a lower end of the lever main body 31. The impact lever 3 is pivotally attached to the support member 2 by fitting a lever-rotating shaft 37 to shaft fit-in holes 35, 35 formed at the axial attachment supporting parts 34, 34 of the lever main body 31 through the lever shaft holes 25, 25 of the support member 2. The rotating shaft impact part 33 for pushing down the pedal-rotating shaft 16 of the pedal arm 1 is formed by depressing the lower edge at an equal distance from a center of rotation of the impact lever 3 (axial center of the lever-rotating shaft 37) to the pedal-rotating shaft 16 of the pedal arm 1 along the pedal-rotating shaft 16. As described above, the rotating-shaft impact part 33 does not contact the pedal rotating shaft 16 in the normal state, and does not inhibit an operation of the pedal arm 1.

As shown in FIG. 4, the impact lever 3 of the present example is made of a pair of plate materials, where the rotating-shaft impact part 33, 33 is formed, and the pedal rotating shaft 16 is pushed down at two points distant in an extending direction. Thus, the pedal-rotating shaft 16 pushed by each of the rotating-shaft impact parts 33, 33 is pushed downward while maintaining the left and right parallelism without tilting. The rotating-shaft impact parts 33, 33 are desirably formed as far as possible, and thus as illustrated in FIG. 5, the portion of the lever main body 31 to be formed with the rotating-shaft impact parts 33, 33 may be spread open in the left and right direction (left and right direction in plane of drawing in FIG. 5) and the rotating-shaft impact parts 33, 33 may be formed at the portion of the lever main body 31 that is spread open.

Since the pedal-rotating shaft 16 breaks the lower site of the pedal shaft hole 24 and allows the pedal arm 1 to drop, the lower site of the pedal shaft hole 24 is demanded a structural strength that can be broken when pushed by the pedal-rotating shaft 16. The pedal device of the present example has the pedal shaft hole 24 formed at the arm supporting arm 22, which is a flange, and the lower site of the pedal shaft hole 24 is a plate material of narrow width. Thus, the structural strength of the lower site of the pedal shaft hole 24 can be easily set by a size of a width W from an inner peripheral edge of the pedal shaft hole 24 to a peripheral edge of the support member 2 positioned on the lower side of the pedal shaft hole 24.

Specifically, if the plate material configuring the arm supporting part 22 is made of a typical soft steel plate (hot rolled soft steel plate: SPHC (Steel Plate Hot Commercial), tensile strength of 270 MPa) and has a plate thickness of 1.6 mm, the width W is between 3 and 5 mm, and preferably approximately 4 mm. When adjusting the structural strength of the lower site of the pedal shaft hole 24 regardless of the plate thickness and type of the plate material configuring the arm supporting part 22, the cleavage eliciting portion 261 made of cutout and the like is desirably formed at the peripheral edge of the support member 2, as illustrated in FIG. 6. In this case, if the width W is 4 mm, the width (depth of the cutout) of the cleavage eliciting portion 261 is targeted to between ⅓ to ⅔ of the width W, that is, between 1.3 mm and 2.7 mm.

The pedal device of the present example has the removal part 26 copying the pedal shaft hole 24 formed from the edge of the arm supporting part 22 of the support member 2 so that the lower site of the pedal shaft hole 24 is easily breakable, but as shown in FIG. 7 and FIG. 8, if the arm supporting part 22 is a member having long width in an up and down direction, the opening 28 copying the pedal shaft hole 24 may be formed and the lower site of the arm supporting parts 22, 22 may be spread in the left and right direction as opened parts 29, 29 to avoid interference with the pedal-rotating shaft 16 that breaks the lower site of the pedal shaft hole 24 and drops. In other words, the lower site of the pedal shaft hole 24 merely needs to be a width that can be broken by the pedal-rotating shaft 16, and either the removal part 26 (present example, see FIG. 1) or the opening 28 (another example, see FIG. 7) can be formed depending on the width of the arm supporting part 22.

The pedal device of the present invention drops the pedal arm 1 when the vehicle collides according to the following procedures. If the vehicle collides, the dash panel 4 goes back towards the driver by being pushed by an engine and the like, as illustrated in FIG. 9. The pedal arm 1 and the impact lever 3 are respectively pivotally attached to the support member 2 that integrally moves by being attached on the dash panel 4, and thus the impact lever 3 moves the deck contacting part 32 closer to the deck cross member 5 with the backward movement of the dash panel 4. The dash panel 4 does not go back horizontally but normally goes back slightly upward, but the deck contacting part 32 of the impact lever 3 can be reliably collided to the deck cross member 5 since the deck guide base 23 of the support member 2 is slidably brought into contact with the support guide rail 51 of the deck cross member 5 from the lower side in the present example.

The deck cross member 5 is a structural member configuring a frame of the vehicle, and is relatively fixed in position with respect to the dash panel 4 that goes back at the time of collision of the vehicle. Thus, the impact lever 3 that goes back with the dash panel 4 collides the deck contacting part 32 to the deck cross member 5 that is relatively fixed in position, breaks the position holding part 36, and as illustrated in FIG. 10, starts the rotation towards the lower side, that is, the impact lever 3 is brought down. When the position holding part 36 is broken, the impact lever 3 released with all regulations is brought down with the deck contacting part 32 pushed by the deck cross member 5.

The impact lever 3 that is brought down collides the rotating-shaft impact part 33 to the pedal-rotating shaft 16 and pushes down the pedal arm 1. The pedal-rotating shaft 16 then plastically deforms and pushes open the lower site of the pedal shaft hole 24, and finally breaks the lower site, and drops the pedal arm 1, as illustrated in FIG. 11. In the present example, the link rod 14 is connected to the pedal arm 14, and thus the pedal arm 1 does not drop to the floor surface and is in a state suspended to the link rod 14. Since the lower site of the pedal shaft hole 24 is ripped to the front and the back and broken (see FIG. 11), the cleavage eliciting portion 261 (see FIG. 6) such as cutout may be formed for the purpose of promoting such a breakage. In this case, the cleavage eliciting portion 261 is not provided for the purpose of adjusting the structural strength of the lower site of the pedal shaft hole 24, and thus the width W of the lower site is preferably set slightly large.

1. A pedal device far a vehicle configured by mounting a support member for rotatably supporting a pedal arm on a dash panel positioned forward of a deck cross member; wherein
the pedal arm is pivotally attached to the support member by inserting a pedal-rotating shaft through a pedal shaft hole of the support member, and an impact lever brought down toward the pedal-rotating shaft is pivotally attached to the support member above the pedal arm and forward of the deck cross member, a lower site of a pedal arm shaft hole provided on the support member being a plate material of narrow width, and
the dash panel goes back towards the driver when the vehicle collides thereby colliding the deck cross member relatively fixed in position with respect to the dash panel and the deck contacting part of the impact lever, and the impact lever is brought down towards the pedal-rotating shaft to break the lower site of the pedal arm shaft hole of narrow width and drops the pedal arm downward.

2. The pedal device according to claim 1, wherein the impact lever includes a pair of rotating-shaft impact parts spaced apart in an extending direction of the pedal-rotating shaft.

3. The pedal device according to claim 1, wherein the impact lever is held in a position not interfering with the pedal-rotating shaft in a normal state by a position holding part arranged on the support member.

4. The pedal device according to claim 1, wherein the support member includes a cleavage eliciting portion at a lower site of the pedal shaft hole pivotally attached with the pedal-rotating shaft to which the impact Lever is brought down.
